(19) United States
(12) Patent Application Publication
(10) Pub. No.: US 2013/0186966 A1
(43) Pub. Date: Jul. 25, 2013

(54) HIGHLY-EFFICIENT, HOT-WATER GENERATING, CAR-MOUNTED HEATER WITH INTERNAL LIQUID FLOW PATH

(71) Applicant: Koshiro Taguchi, Yokohama-shi (JP)

(72) Inventor: Koshiro Taguchi, Yokohama-shi (JP)

(21) Appl. No.: 13/810,966

(22) PCT Filed: Jan. 31, 2011
(86) PCT No.: PCT/JP2011/051902

§ 371 Date: Apr. 8, 2013

(30) Foreign Application Priority Data
Jul. 21, 2010 (JP) 2010-163982
Aug. 26, 2010 (JP) PCT/JP2010/064458

(51) Int. Cl. B60H 1/22; F24D 13/04

(52) U.S. Cl. CPC B60H 1/2221; F24D 13/04
USPC 237/57; 392/496

(57) ABSTRACT

A highly-efficient, hot-water generating, car-mounted heater with an internal liquid flow path includes a heater unit and a case. The heater unit includes a PTC element, an electrode plates, an insulating sheet, a tube body, a seal, and a radiator. The radiator is provided on the radiation faces of the tube body. The radiator has a plurality of fins, and a plurality of flow paths that are partitioned by the plurality of fins and extend in a direction that intersects with the longitudinal direction of the tube body. The heater unit is housed in the case with one ends of the flow paths of the radiator made to oppose the flow inlet and the other ends of the flow paths made to oppose the flow outlet.

### TECHNICAL FIELD

The invention relates to a highly-efficient, hot-water generating, car-mounted heater with an internal liquid flow path that is mounted in an automobile, and relates particularly to a highly-efficient, hot-water generating, car-mounted heater with an internal liquid flow path using a PTC (positive temperature coefficient) element for a heat generating source.

### BACKGROUND

In general, as a main heat source for heating inside of an automobile, a hot water heater is used that utilizes exhaust heat of engine cooling water to heat air. Along with spread of electric vehicles and the like without an engine in the future, there is a strong request from the market for utilizing a conventionally used system of heating with hot water with no change. From such request by the market, electric hot water heaters are demanded.

One using a PTC element as a heating element in an electric heater is disclosed in, for example, Patent Document 1. In Patent Document 1, there are disclosed a structure that a heating unit having a PTC element sandwiched by insulating plates is put into a concave portion, and further a technique that a liquid flows around there to heat the liquid.

### CITATION LIST

### Patent Literature

[Patent Document 1] Japanese Patent Application Laid Open No. 2008-7106

### SUMMARY OF INVENTION

### Technical Problem

In the technique disclosed in Patent Document 1, a heating unit having a PTC element sandwiched by insulating plates is only inserted into a concave portion that is integrated with a fluid circulating chamber, and heat exchange is not performed sufficiently and it is inefficient.

In addition, when the heat exchange efficiency is low, a large number of PTC elements need to be used, which turns out to lead an increase in costs and weight.

In addition, the flow of the liquid inside the liquid circulating chamber is not designed to forcibly flow the liquid in an efficient flow path. Therefore, there is a concern that stagnation and a vortex develop in the liquid due to the vibration and the tilt during vehicle running to inhibit efficient heat exchange.

The invention has been made in view of the above problems, and provides a highly-efficient, hot-water generating, car-mounted heater with an internal liquid flow path that is excellent in the heat exchange efficiency between a heat generating component and a liquid.

According to an aspect of the embodiment of the invention, there is provided a highly-efficient, hot-water generating, car-mounted heater with an internal liquid flow path including: a heater unit, including a PTC (positive temperature coefficient) element having a pair of electrode faces, a pair of electrode plates bonded to each of the pair of electrode faces sandwiching the PTC element, an insulating sheet wrapping the PTC element and the electrode plates, and having flexibility, thermal conductivity, and electrical insulating properties, a tube body in a flattened shape housing the PTC element and the electrode plates wrapped in the insulating sheet, and having a pair of radiation faces in a plate shape opposed to each of the pair of electrode faces, a seal material sealing openings in both end portions of the tube body in a longitudinal direction, and a radiator provided on the radiation faces of the tube body, and having a plurality of fins and a plurality of flow paths that are partitioned by the plurality of fins and extend in a direction that intersects with the longitudinal direction of the tube body; and a case having a flow inlet for a liquid and a flow outlet for the liquid. The heater unit is housed between the flow inlet and the flow outlet in the case with one ends of the flow paths of the radiator made to oppose the flow inlet and the other ends of the flow paths made to oppose the flow outlet.

According to another aspect of the embodiment of the invention, there is provided a highly-efficient, hot-water generating, car-mounted heater with an internal liquid flow path including: a case having an internal space in which a liquid flows; and a heater unit housed in the internal space and performing heat exchange by directly contacting the liquid. The heater unit includes a PTC (positive temperature coefficient) element having an electrode face, an electrode plate bonded to the electrode face, an insulator overlapped at least on a face of the electrode plate on the side opposite to the PTC element, a tube body housing the PTC element, the electrode plate, and the insulator, and having a radiation face opposed to the electrode face of the PTC element, a seal material sealing openings in both end portions of the tube body, and a radiator provided on the radiation face of the tube body and having a fin forming a flow path in which the liquid flows. One end portion of the tube body is located outside the internal space of the case, and one end portion of the electrode plate protrudes from the one end portion of the tube body to outside the case to be connected to an electric cable.

According to another aspect of the embodiment of the invention, there is provided a highly-efficient, hot-water generating, car-mounted heater with an internal liquid flow path including: a case in which a liquid flows inside; and a heater unit housed inside the case and performing heat exchange by directly contacting the liquid. The heater unit includes a PTC (positive temperature coefficient) element having an electrode face, an electrode plate bonded to the electrode face, an insulator overlapped at least on a face of the electrode plate on the side opposite to the PTC element, a tube body housing the PTC element, the electrode plate, and the insulator, and having a radiation face opposed to the electrode face of the PTC element, a seal material sealing openings in both end portions of the tube body, and a radiator provided on the radiation face of the tube body and having a fin forming a flow path in which the liquid flows. The case includes a main body portion having an internal space to house the heater unit and a flowing water introduction portion provided in one end of the main body portion. The flowing water introduction portion includes a flow inlet for the liquid and a flowing water introduction space provided between the flow inlet and the internal space, having a cross-sectional area enlarged from the flow inlet toward the internal space, and facing one end of the flow path formed in the radiator.

According to the invention, a highly-efficient, hot-water generating, car-mounted heater with an internal liquid flow path that has high heat exchange efficiency between a heat generating component and a liquid is provided. By enhancing the heat exchange efficiency, the number of PTC elements to be used can be reduced and it becomes possible to reduce the weight, the space, and the costs of the entire car-mounted heater.

### BRIEF DESCRIPTION OF DRAWINGS

FIG. 1A is a schematic perspective view of a heater unit in a highly-efficient, hot-water generating, car-mounted heater with an internal liquid flow path according to an embodiment of the invention.

FIG. 1B is a schematic plan view of the heater unit.

FIG. 2A is a schematic plan view of a heat generator in the heater unit.

FIG. 2B is an A-A enlarged cross-sectional view in FIG. 2A.

FIGS. 3A and 3B are schematic perspective views of a case housing the heater unit.

FIG. 4A is a schematic perspective view showing an electrode connection of the heater unit housed in the case.

FIG. 4B is a schematic plan view of the electrode connection.

FIG. 5 is a schematic cross-sectional view of the case and the heater unit housed in the case.

FIG. 6 is a schematic view of a car-mounted hot-water heater system according to an embodiment of the invention.

FIGS. 7A and 7B are schematic views of another example of the heat generator of the embodiment.

FIG. 8 is a schematic view of still another example of the heat generator of the embodiment.

FIG. 9A is a schematic view of another example of the heat generator of the embodiment.

FIG. 9B is a schematic view of a car-mounted heater using the heat generator shown in FIG. 9A.

FIG. 10 is a schematic view of another example of the heater unit of the embodiment.

FIG. 11 is a schematic view of still another example of the heater unit of the embodiment.

FIG. 12 is a schematic view of still another example of the heater unit of the embodiment.

FIG. 13 is a schematic view of still another example of the heater unit of the embodiment.

FIG. 14 is a schematic view of still another example of the heater unit of the embodiment.

FIGS. 15A and 15B are appearance views of a case of another embodiment.

FIG. 16 is a front view of the left side in FIGS. 15A and 15B.

FIGS. 17A and 17B are schematic views of a part of a flowing water introduction portion in the case of the other embodiment.

FIG. 18 is a schematic perspective view of the flowing water introduction portion in the case of the other embodiment.

FIG. 19 is a table showing examination results of a hot-water generating car-mounted heater using the heater of the other embodiment.

FIGS. 20A and 20B are graphs showing examination results of FIG. 19.

FIG. 21 is a schematic view of a hot-water generating car-mounted heater using a heater of a comparative example.

FIG. 22 is a table showing examination results of the hot-water generating car-mounted heater of the comparative example.

FIGS. 23A and 23B are graphs showing examination results of FIG. 22.

FIG. 24 is a schematic view of another example of a diffusion guiding portion in the flowing water introduction portion.

### DESCRIPTION OF EMBODIMENTS

Embodiments of the invention will now be described with reference to the drawings. In the drawings, same components are marked with like numerals.

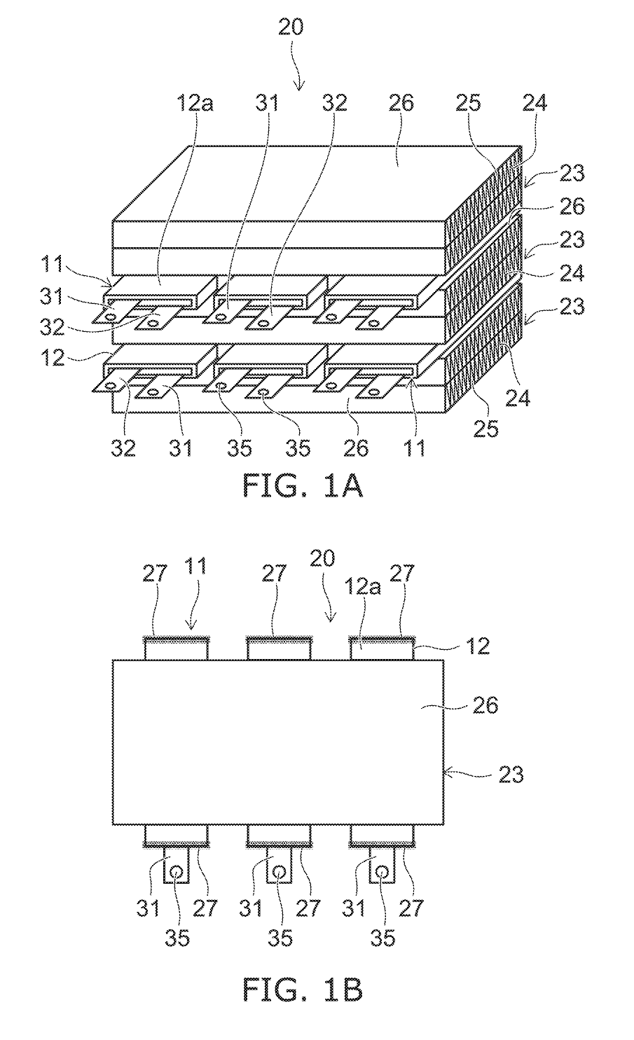

FIG. 1A is a schematic perspective view of a heater unit in a highly-efficient, hot-water generating, car-mounted heater with an internal liquid flow path (hereinafter, may also be referred to simply as a car-mounted heater) according to an embodiment of the invention. FIG. 1B is a schematic plan view of the same heater unit 20.

The heater unit 20 has a structure that a plurality of heat generators 11 are stacked with a plurality of radiators 23. The number of heat generators 11, the number of radiators 23, and the number of stacking layers of the heat generators 11 and the radiators 23 are optional and are not limited to the number shown in the drawings.

Firstly, the heat generators 11 are described.

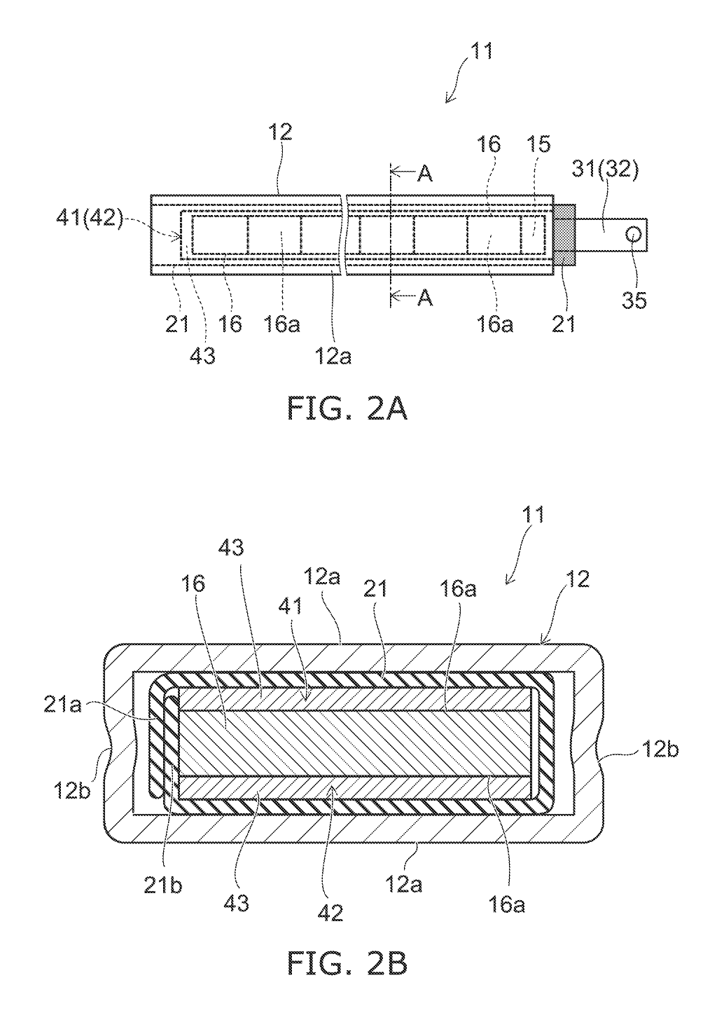

FIG. 2A is a schematic plan view of one of the heat generators 11. FIG. 2B is an A-A enlarged cross-sectional view in FIG. 2A.

The heat generator 11 has a PTC (positive temperature coefficient) element 16 as a heat generating element. The PTC element 16 is a ceramic element with positive temperature characteristics, and when it becomes at a temperature not less than the Curie point, the resistance rapidly increases and a more temperature rise is restricted.

The PTC element 16 is formed, for example, in a rectangular thin plate piece shape, and has its both front and back faces with electrode faces 16a made of metal, such as silver and aluminum, for example, formed thereon. The plurality of PTC elements 16 are disposed along a longitudinal direction of tube bodies 12 inside the tube bodies 12.

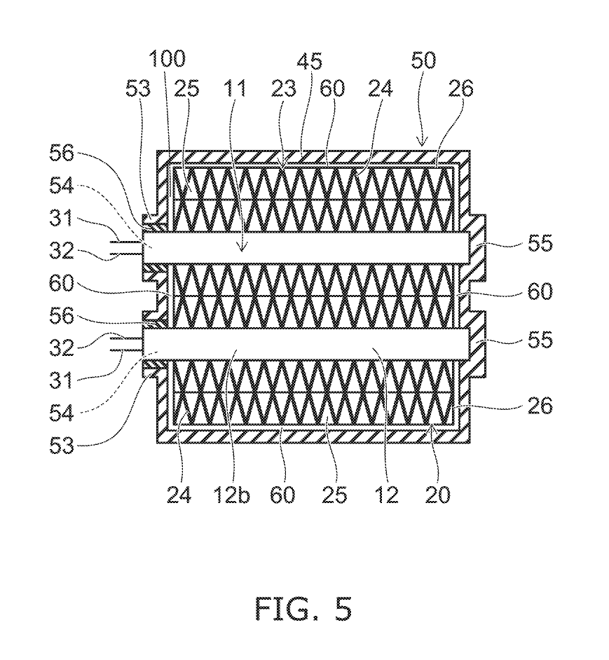

Both end portions of the tube body 12 in a longitudinal direction is located outside an internal space 100 of a case 50 as described later with reference to FIG. 5. In the both end portions of the tube body 12, no PTC element 16 is housed as shown in FIG. 2A.

In particular, in one end portion of the tube body 12, an insulating spacer 15 is housed. The spacer 15 is interposed between an electrode plate 41 and an electrode plate 42 instead of the PTC element. The spacer 15 is, for example, alumina in a plate shape. In addition, as the spacer 15, it is also possible to use a ceramic material. The spacer 15 does not have an electrode face, and is not energized. Accordingly, the spacer 15 does not generate heat.

To the pair of electrode faces 16a of the PTC element 16, the respective electrode plates 41, 42 are bonded. The PTC element 16 is sandwiched in between the pair of electrode plates 41, 42. To the pair of electrode plates 41, 42, reversed polarity voltages are applied, respectively.

The electrode plates 41, 42 are made of metal, such as aluminum, SUS (stainless steel), and copper, for example. The one electrode plate 41 has a flat plate portion 43 and an electrode terminal 31 that is provided integrally with one end of the flat plate portion 43. The other electrode plate 42 also has a flat plate portion 43 and an electrode terminal 32 that is provided integrally with one end of the flat plate portion 43.

As shown in FIG. 2B, the flat plate portions 43 are overlapped on the electrode faces 16a of the PTC element 16 inside the tube body 12. The flat plate portion 43 and the electrode faces 16a are bonded with, for example, a silicone-based adhesive that is excellent in thermal conductivity.

By thermal spraying, for example, aluminum on the front and back faces of the PTC element 16, the electrode faces 16a are formed. Alternatively, by applying, for example, silver paste on the front and back faces of the PTC element 16, the electrode faces 16a are formed. Or, by applying silver paste on the front and back faces of the PTC element 16, followed by thermal spraying aluminum, the electrode faces 16a are formed. Therefore, minute concavity and convexity are formed in the electrode faces 16a.

Accordingly, even when the adhesive to bond the electrode faces 16a and the flat plate portion 43 is insulating, the concave portion in the concavity and convexity in the electrode faces 16a penetrates the adhesive and contacts the flat plate portion 43, and conduction between the PTC element 16 and the electrode plates 41, 42 can be secured. To reduce the contact resistance, thermal spraying of aluminum is more desired.

The tube body 12 has openings in both end portions in its longitudinal direction. From the openings in the one end portion of the tube bodies 12, as shown in FIG. 2A, the electrode terminals 31, 32 protrude outside the tube bodies 12. In each of the electrode terminals 31, 32, a threaded hole 35 is formed.

As shown in FIG. 2B, the electrode plates 41, 42 and the PTC element 16 that is sandwiched by them are wrapped in an insulating sheet 21. The insulating sheet 21 has flexibility, thermal conductivity, and electrical insulating properties, and is a polyimide film, for example. Both end edge portions 21a, 21b of the insulating sheet 21 are overlapped on each other, and the insulating sheet 21 covers all of the flat plate portion 43 and a portion of the electrode terminals 31, 32.

Both end edge portions 21a, 21b of the insulating sheet 21 overlap each other, not between the electrode faces 16a of the PTC element 16 and radiation faces 12a of the tube body 12, but on back sides of the side faces 12b of the tube body 12. This enables to suppress a decrease in the heat transfer efficiency from the PTC element 16 to the radiation faces 12a of the tube body 12.

The tube body 12 is formed in a flattened shape having the pair of radiation faces 12a that are opposed to each other and the pair of side faces 12b that are formed approximately at a right angle to the radiation faces 12a and are opposed to each other. The radiation faces 12a have a wider width and a larger area than the side faces 12b. The tube body 12 is made of a material having thermal conductivity and easy processability, such as aluminum, for example.

The PTC element 16 and the electrode plates 41, 42 are housed inside the tube body 12 in a state of being covered around with the insulating sheet 21. The electrode faces 16a of the PTC element 16 are located on back sides of the radiation faces 12a of the tube body 12. Between one of the electrode faces 16a and one of the radiation faces 12a, the electrode plate 41 and the insulating sheet 21 are clamped. Between the other electrode face 16a and the other radiation face 12a, the electrode plate 42 and the insulating sheet 21 are clamped.

After insertion of the PTC element 16 and the electrode plates 41, 42 wrapped in the insulating sheet 21 into the tube body 12, mechanical pressure is applied to the pair of radiation faces 12a of the tube body 12 to squeeze the tube body 12 in a vertical direction in FIG. 2B. This causes the PTC element 16, the electrode plates 41, 42, and the insulating sheet 21 to be in a state of being clamped between the back faces of the pair of radiation faces 12a of the tube body 12 and to be fixed in the tube body 12.

Accordingly, between the electrode faces 16a of the PTC element 16 and the back faces of the radiation faces 12a, no gap is formed. Therefore, it is possible to secure a heat transfer route without an air layer to be interposed over a wide area between the PTC element 16 and the radiation faces 12a of the tube body 12, and it is possible to improve the heat transfer efficiency.

Since grooves or recesses are formed in the side faces 12b of the tube body 12 along the longitudinal direction, it is possible to prevent the side faces 12b from bulging outward when the tube body 12 is squeezed.

In addition, as shown in FIG. 2A, a portion of the insulating sheet 21 protrudes from the opening in one end portion of the tube body 12 to outside the tube body 12 to cover a portion of the electrode terminals 31, 32. This enables to certainly prevent a short circuit between the electrode terminals 31, 32 and the tube body 12.

As shown in FIG. 1B, in the openings of the both end portions of the tube body 12, for example, a silicone-based sealant 27 having electrical insulating properties, waterproof properties, and heat resistance is filled. This sealant 27 prevents infiltration of a liquid into the tube body 12.

Next, the radiators 23 are described.

As shown in FIG. 1A, the radiator 23 has a plurality of fins 24 and metal plates 26 surrounding around the fins 24. The fins 24 are configured by folding, for example, an aluminum plate in zigzag. The metal plates 26 are made of metal that is excellent in thermal conductivity, such as aluminum, for example.

The folded portions of the fins 24 are bonded to the metal plates 26 with, for example, a silicone-based adhesive that is excellent in heat resistance and thermal conductivity. Inside the metal plates 26, a plurality of flow paths 25 are formed that are partitioned by the plurality of fins 24. The shape of fins 24 and the cross sectional shape of flow paths 25 are not limited to the shown shapes and the entire radiators 23 may also be in, for example, a honeycomb structure. The radiators 23 may have a structure that can form flow paths in which a liquid flows.

The radiators 23 are stacked onto the radiation faces 12a of the tube body 12, and the heat generator 11 is sandwiched between the radiator 23 and the radiator 23. The metal plates 26 and the radiation faces 12a are bonded with, for example, a silicone-based adhesive that is excellent in heat resistance and thermal conductivity. In addition, aluminum powder, for example, is mixed to this silicone-based adhesive to enhance the thermal conductivity more. In addition, the radiators 23 may also be fixed to the radiation faces 12a of the tube body 12 by brazing, soldering, or the like. Alternatively, the fins 24 may also be provided integrally with the radiation faces 12a of the tube body 12.

The fins 24 are repeated in zigzag along the longitudinal direction (referred to as a first direction) of the tube body 12. The portions in a plate shape of the fins 24 to be side walls of the flow paths 25 extend in a direction that intersects with the first direction (second direction). Accordingly, the flow paths 25 extend in the second direction. The first direction and the second direction are, for example, orthogonal. Accordingly, the longitudinal direction of the tube body 12 and the direction in which the flow paths 25 of the radiators 23 extend are orthogonal. The longitudinal direction of the tube body 12 and the direction in which the flow paths 25 of the radiators 23 extend are not limited to be orthogonal and may also cross obliquely.

As shown in FIG. 1B, the both end portions of the tube body 12 in the longitudinal direction protrude from the radiators 23 and do not overlap with the radiators 23. As described later with reference to FIG. 5, both end portions of the tube body 12 protruding from the radiators 23 are attached to the case 50.

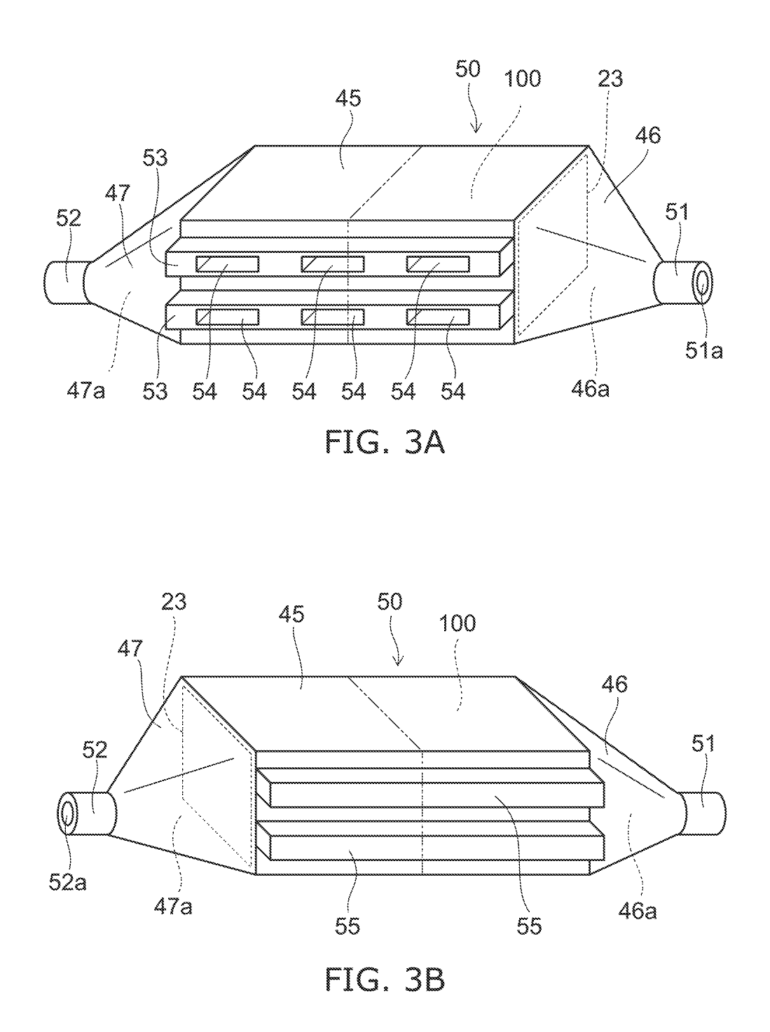

Next, FIG. 3A shows a schematic perspective view of the case 50. FIG. 3B is a schematic perspective view of a back side in FIG. 3A.

The case 50 is made of resin, for example, and is made by welding two molded articles divided at a double dotted line in FIG. 3A and FIG. 3B. After housing the heater unit 20 described above in the case 50, the two molded articles are welded at the position of the double dotted line. Alternatively, the case 50 may also be made of metal.

The case 50 has one end potion in the longitudinal direction provided with a flow inlet portion 51 of a liquid and has the other end portion provided with a flow outlet portion 52 of a liquid. The flow inlet portion 51 and the flow outlet portion 52 are formed in, for example, a cylindrical shape. The flow inlet portion 51 has a flow inlet 51a formed therein, and the flow inlet 51a is communicated with inside of the case 50. The flow outlet portion 52 has a flow outlet 52a formed therein, and the flow outlet 52a is communicated with inside of the case 50.

The case 50 has a main body portion 45, a flowing water introduction portion 46, and a flowing water lead-out portion 47. The main body portion 45 is formed in, for example, a rectangular tube shape and has its one end provided with the flowing water introduction portion 46. In the other end of the main body portion 45, opposed to the flowing water introduction portion 46, the flowing water lead-out portion 47 is provided.

In the main body portion 45, the internal space 100 is formed that houses the heater unit 20 described above. Between the internal space 100 and the flow inlet portion 51, the flowing water introduction portion 46 is provided. The flowing water introduction portion 46 has an external shape formed in, for example, a truncated pyramid shape and has a flowing water introduction space 46a formed inside that has a cross-sectional area gradually enlarged from the flow inlet 51a toward the internal space 100 of the main body portion 45.

The flowing water introduction space 46a is linked to the flow inlet 51a and the internal space 100 of the main body portion 45. An end potion of the flowing water introduction portion 46 on the side of the main body portion 45 covers the entire one end portion of the internal space 100.

Between the internal space 100 of the main body portion 45 and the flow outlet portion 52, the flowing water lead-out portion 47 is provided. The flowing water lead-out portion 47 has an external shape formed in, for example, a truncated pyramid shape and has a flowing water lead-out space 47a formed inside that has a cross-sectional area gradually decreased from the internal space 100 toward the flow outlet 52a.

The flowing water lead-out space 47a is linked to the internal space 100 of the main body portion 45 and the flow outlet 52a. An end potion of the flowing water lead-out portion 47 on the side of the main body portion 45 covers the entire other end portion of the internal space 100.

The external shapes of the flowing water introduction portion 46 and the flowing water lead-out portion 47 are not limited to the truncated pyramid shape and may also be in a truncated cone shape, a pyramid shape, and a conical shape.

The main body portion 45 has, for example, four side faces. One side face among those four side faces is provided with an electrode connection 53 as shown in FIG. 3A. The electrode connection 53 protrudes outside the case 50 from the side face of the main body portion 45. Inside the electrode connection 53, a plurality of slits 54 are formed. The slits 54 are communicated with the internal space 100 of the main body portion 45.

On a side face opposite to the side face in which the electrode connection 53 is provided, fitting portions 55 are provided as shown in FIG. 3B. The fitting portions 55 protrude to a side opposite to the electrode connection 53 from the side face of the main body portion 45. Inside the fitting portions 55 is formed a concave portion facing inside the case 50 as shown in FIG. 5. The fitting portions 55 do not have a slit or an opening formed therein and the concave portions are not communicated with outside of the case 50.

The heater unit 20 is housed in the internal space 100 of the main body portion 45. One ends of the flow paths 25 of the radiators 23 are made to face the flowing water introduction space 46a. The other ends of the flow paths 25 made to face the flowing water lead-out space 47a. Accordingly, in the case 50, the flow paths 25 of the radiators 23 extend in a direction joining the flow inlet 51a to the flow outlet 52a. A portion of the heater unit 20 may also enter the flowing water introduction space 46a or the flowing water lead-out space 47a.

In addition, the longitudinal direction of the tube body 12 extends in a direction that intersects with the direction joining the flow inlet 51a to the flow outlet 52a.

FIG. 5 corresponds to a cross section viewed from the side face 12b side of the tube body 12.

One end portion of the tube body 12 in the longitudinal direction is located in the slit 54 formed in the electrode connection 53 of the case 50. Between the tube body 12 and the inner walls of the electrode connection 53, a sealant 56 is interposed. This sealant 56 enables to prevent a liquid introduced into the case 50 from leaking out through the slit 54 to outside the case 50.

The other end portion of the tube body 12 fits in the fitting portion 55 provided in the case 50. Accordingly, the both end portions of the tube body 12 protruding from the radiators 23 are attached to the case 50. The radiators 23 do not contact the inner walls of the case 50, and a gap 60 exists between the radiators 23 and the inner walls of the case 50. That is, the both end portions of the tube body 12 protruding from the radiators 23 are supported by the case 50, and the radiators 23 are in a state of floating in the internal space of the case 50.

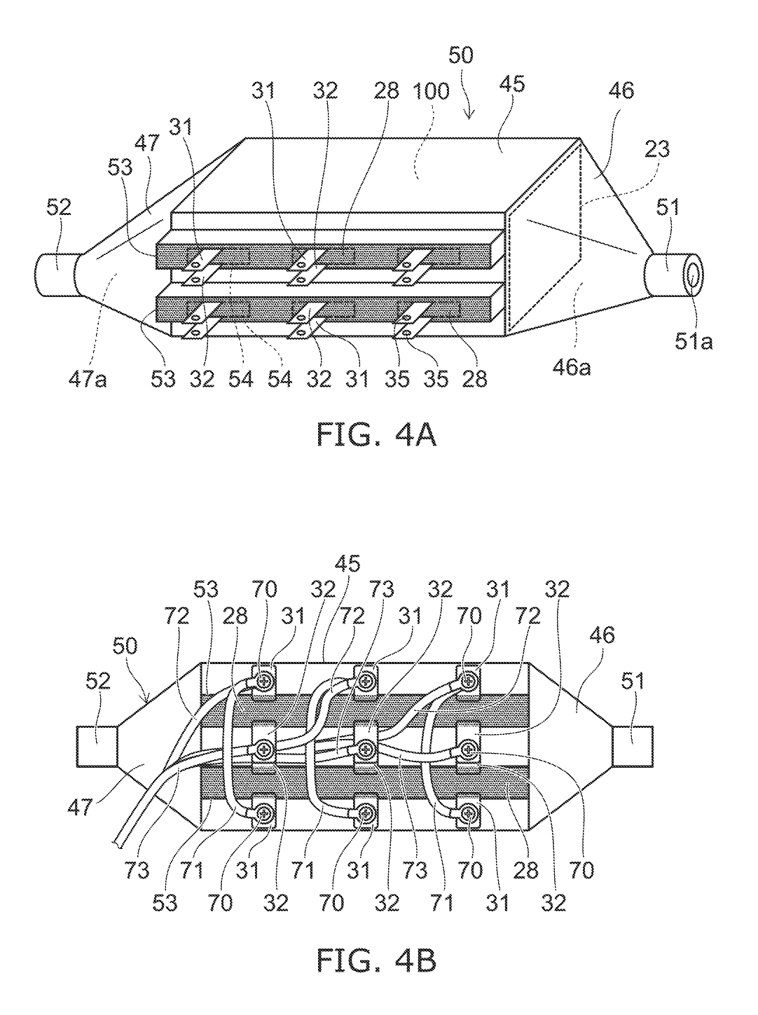

The electrode terminals 31, 32 protrude to outside of the case 50 from the slits 54. On the electrode connection 53, a silicone-based sealant 28, for example, is applied as shown in FIG. 4A and FIG. 4B to block the slits 54. In addition, the sealant 28 also blocks the openings in the tube bodies 12. As the sealant, a rubber packing may also be used, for example.

The electrode terminals 31, 32 protruding to outside of the electrode connection 53 are folded as shown in FIG. 4B and connected to electric cables 71 through 73. Each of the electric cables 71 through 73 has an end portion fastened with screws to each of the electrode terminals 31, 32. That is, the end portion of each of the electric cables 71 through 73 is overlapped on the threaded hole 35 formed in each of the electrode terminals 31, 32 and a screw 70 is fastened in the threaded hole 35.

To the electrode terminal 31 and the electrode terminal 32, mutually reverse polarity voltages are applied. For example, a positive voltage is applied to the electrode terminal 31 and a negative voltage to the electrode terminal 32.

In the example shown in FIG. 4A and FIG. 4B, the electrode terminals 31 are located in both ends of the heat generators 11 in a stacking direction. The electrode terminals 32 of each of the heat generators 11 adjacent in the stacking direction are adjacent in the stacking direction.

The electrode terminals 31 in both ends in the stacking direction are connected to each other by the electric cables 71. Then, the electrode terminals 31 on an upper side in FIG. 4B, for example, are connected to the electric cables 72. The electric cables 72 are connected to a power supply, not shown.

The electrode terminals 32 adjacent in the stacking direction are folded and the threaded holes 35 are overlapped on each other. Then, end portions of the electric cables 73 are overlapped on the overlapped electrode terminals 32, and the screws 70 are fastened in the threaded holes 35. This causes the electrode terminals 32 to be connected to the electric cables 73. The electric cables 73 are connected to a power supply, not shown.

The car-mounted heater according to the embodiment is mounted in an automobile and is used as a heater for space heating in the car. Then, power from a battery mounted in the automobile is supplied via the electric cables 72, 73 and the electrode terminals 31, 32 to the PTC elements 16, and the PTC elements 16 generate heat.

The heat is transferred via the electrode plates 41, 42 and the insulating sheets 21 to the radiation faces 12a of the tube bodies and is transferred further to the radiators 23 stacked on the radiation faces 12a. That is, the plurality of fins 24 are heated.

Into the case 50, a liquid (for example, water) is introduced. The liquid flows into the case 50 from the flow inlet 51a. The liquid inflowing from the flow inlet 51a is lead through the flowing water introduction space 46a to the flow paths 25 of the radiators 23 housed in the internal space 100.

The flowing water introduction space 46a is formed to have a cross-sectional area gradually enlarged from the flow inlet 51a side toward the internal space 100. Therefore, it is possible to lead the liquid inflowing from the flow inlet 51a by diffusing uniformly to all of the flow paths 25 formed in the radiators 23. As a result, it is possible to achieve high heat exchange efficiency.

The plurality of flow paths 25 are partitioned by the plurality of heated fins 24, the radiation faces 12a of the tube bodies 12, and the metal plates 26. Accordingly, the liquid flowing in the flow paths 25 is heated by the heat exchange between the fins 24, the radiation faces 12a, and the metal plates 26, and flows out through the flowing water lead-out space 47a from the flow outlet 52a to outside of the case 50. That is, the heater unit 20 performs heat exchange highly efficiently by directly contacting the liquid.

The space in the end portion on the main body portion 45 side in the flowing water introduction space 46a and the space in the end portion on the main body portion 45 side in the flowing water lead-out space 47a extend over almost the entire cross section of the internal space 100. Therefore, it is possible to flow the liquid uniformly with no bias in a cross sectional direction from end to end of all of the flow paths 25 built in the heater unit 20. As a result, it is possible to achieve high heat exchange efficiency.

The liquid flows in a depth direction of the paper in the plurality of flow paths 25 shown in FIG. 5. The tube bodies 12 have the side faces 12b directed to the flow inlet 51a side. That is, the tube bodies 12 traverse a gap between the radiator 23 and the radiator 23.

The entire volume of the plurality of flow paths 25 is larger than a volume of a space outside the flow paths 25 in the internal space 100. In addition, the entire cross-sectional area of the plurality of flow paths 25 is larger than a cross-sectional area of the gap 60 between the periphery of the radiators 23 and the case 50.

Accordingly, most of the liquid inflowing from the flow inlet 51a flows in the flow paths 25 surrounded by heated portions. With a structure that the liquid forcibly passes through the flow paths 25 built in the heater unit 20 in such a manner, it is possible to secure a large contact area of the liquid with the heated portions, and it is possible to perform heat exchange efficiently.

In addition, the gap 60 exists between the radiators 23 and the case 50, and the radiators 23 do not contact the case 50. Therefore, it is difficult for the heat of the radiators 23 to escape to the case 50. This also improves the heat exchange efficiency between the radiators 23 and the liquid. In addition, even in a state that the liquid in the case 50 is lost and the case 50 enters a state of boil dry, it is difficult for the heat to be transferred to the external case 50 due to the presence of the gap 60.

The PTC elements 16 have properties to discharge more energy as being cooled more. In the embodiment, the entire radiators 23 can efficiently contact the liquid and the liquid efficiently draws the heat from the entire heated portions, and thus it becomes possible to maximally take out the output of the PTC element 16 per sheet. Accordingly, the number of PTC elements 16 to be used can be reduced. As a result, it becomes possible to reduce the weight, the space, and the costs of the entire car-mounted heater, and it is possible to greatly contribute to the society.

In addition, in the embodiment, the PTC elements 16 and the flat plate portions 43 of the electrode plates 41, 42 in contact with the PTC elements 16 are housed inside the tube bodies 12 tightly closed by the sealants 27, 28 and are not exposed to outside. In addition, since the insulating sheets 21 are interposed between the flat plate portions 43 and the tube bodies 12, the tube bodies 12 are not energized. Therefore, the radiators 23 are also not energized. Accordingly, it is safe to house the tube bodies 12 and the radiators 23 in the case 50 in which the liquid flows. That is, while obtaining high heat exchange efficiency by making the heater unit 20 directly contact with the liquid, it is still possible to obtain high safety and reliability.

In addition, the longitudinal direction of the tube bodies 12 intersects with the direction in which the liquid flows. Therefore, no flow of the liquid toward the openings in the end portions of the tube bodies 12 is formed. The both end portions of the tube bodies 12 protrude from the radiators 23 with the built in flow paths 25 for the liquid and further are located outside the internal space 100 in which the liquid flows in the case 50, so that the both end portions of the tube bodies 12 are not soaked in the liquid. As a result, the waterproof properties in the energized portions are more enhanced and high safety is obtained.

The both end portions of the tube bodies 12 that do not contact the liquid do not contribute to the heating of the liquid. In the embodiment, as described above with reference to FIG. 2A, the PTC elements 16 are not housed in the both end portions. Accordingly, it is possible to suppress wasted utilization of power.

In the both end portions of the tube bodies 12, the waterproof sealant is filled. Further, in an end portion to take out the electrode terminals 31, 32, the insulating spacers 15 described above are housed. This enables to reliably prevent contact of electrodes having different polarities.

The both end portions of the tube bodies 12 do not generate heat or are suppressed in an amount of heat generation than the areas having the flow paths 25. Therefore, it is possible to suppress deterioration of the sealants and the electrodes in the end portions of the tube bodies 12.

The spacers 15 are located in the slits 54 of the electrode connection 53 in the case 50 in FIG. 5. Alternatively, the PTC elements 16 may also enter the slits 54 a little. Even in this case, the heat generation in the end portions of the tube bodies 12 can be suppressed compared with the portions having the flow paths 25, and it is possible to suppress deterioration of the electrodes and the sealants in the end portions.

In addition, by directing the longitudinal direction of the tube bodies 12 to the direction that intersects with the direction joining the flow inlet 51a and the flow outlet 52a, it is possible to pull out the electrode terminals 31, 32 protruding from one end portions of the tube bodies 12 to a relatively wide space without spatial restrictions by the flow inlet portion 51 and the flow outlet portion 52. This facilitates connecting procedures with the electric cables.

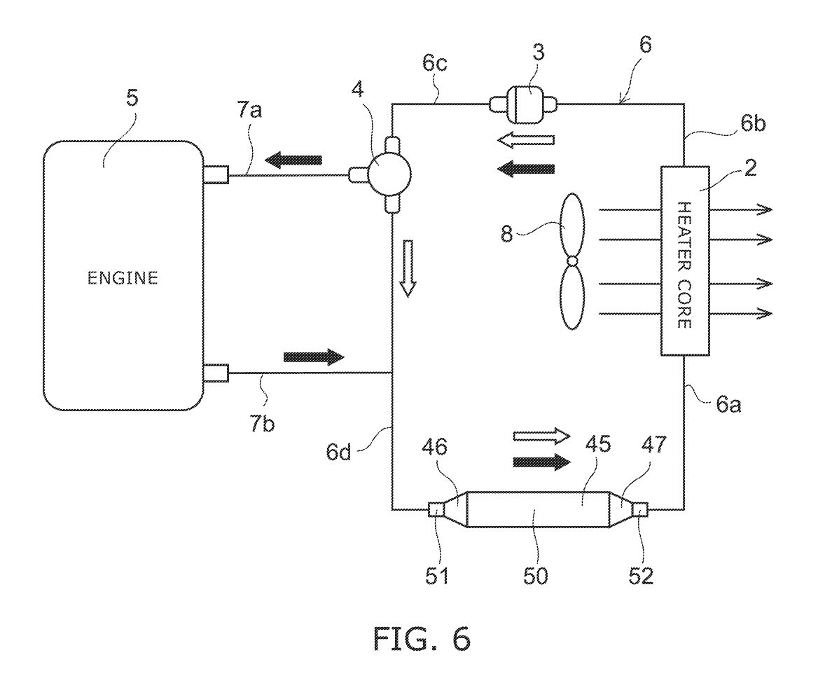

Next, FIG. 6 is a schematic view showing a car-mounted hot-water heater system according to an embodiment of the invention.

FIG. 6 shows a specific example of attaching the car-mounted heater described above to a vehicle, such as an automobile. The case 50 having the heater unit 20 housed therein is connected to a circulation path 6.

The circulation path 6 has pipelines 6a through 6d. The pipeline 6a connects the case 50 to a heater core 2. The pipeline 6b connects the heater core 2 to a hydraulic pump 3. The pipeline 6c connects the hydraulic pump 3 to a three-way valve 4. The pipeline 6d connects the three-way valve 4 to the case 50. The pipeline 6d is connected to the flow inlet portion 51 of the case 50, and the pipeline 6a is connected to the flow outlet portion 52 of the case 50.

In addition, the circulation path 6 and the case 50 are also connected to an engine 5 via pipelines 7a, 7b. When the three-way valve 4 is in a state of interrupting between the pipeline 6c and the pipeline 7a and communicating between the pipeline 6c and the pipeline 6d, as the hydraulic pump 3 is driven, the liquid circulates in the case 50 and the circulation path 6 in a direction shown in a white arrow in FIG. 6.

At this time, by supply of the power from the battery mounted in the vehicle to the heater unit 20 in the case 50, the heater unit 20 generates heat and the liquid in the case 50 is heated. The hot water generated by the heating is supplied to the heater core 2 through the flow outlet portion 52 and the pipeline 6a.

The hot water supplied to the heater core 2 flows in a pipe included in the heater core 2. To the heater core 2, a gas (air) is blown from a blower 8. The heat of the hot water flowing in a pipe of the heater core 2 is transferred via a heat transfer face, such as the fins, included in the heater core 2 to the gas blown from the blower 8. This causes a heated air to be blown in the car. This mode is selected in a case of not being able to utilize the exhaust heat of the engine 5 such as when, for example, starting up the engine 5.

After starting up the engine 5, as the three-way valve 4 is switched to communicate the pipeline 6c with the pipeline 7a and interrupt the pipeline 6c and the pipeline 6d, the liquid is supplied to the engine 5 and functions as cooling water of the engine 5. The flow of the liquid at this time is shown in a black arrow in FIG. 6. The hot water passing through the engine 5 and heated by the heat exchange with the engine 5 is supplied to the heater core 2 via the pipelines 7b, 6d, the flow inlet portion 51, inside the case 50, the flow outlet portion 52, and the pipeline 6a. Accordingly, in a case of this mode, it is possible to supply hot water to the heater core 2 even when the heater unit 20 is not energized (generated heat), and by driving the blower 8, it is possible to blow the heated air into the car.

The car-mounted heater according to the embodiment can be used by being incorporated, with no change, into an existing car-mounted hot-water generation system that utilizes cooling water heated by the exhaust heat of the engine.

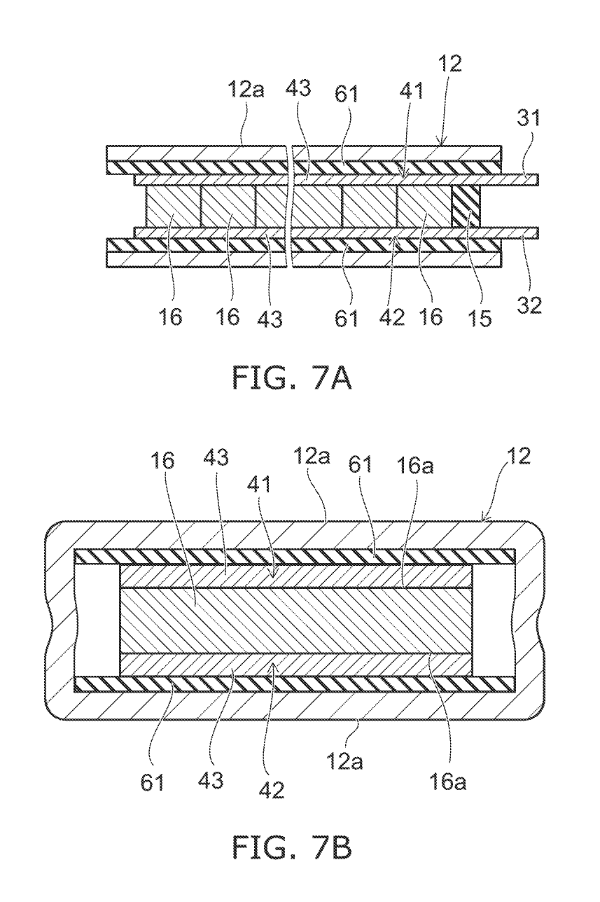

An insulator interposed between the electrode plates 41, 42 and the tube bodies 12 is not limited to an insulating sheet and insulating plates 61 may also be used as shown in FIGS. 7A and 7B.

FIG. 7A shows a cross section along the longitudinal direction of the tube body 12. FIG. 7B corresponds to a cross section similar to FIG. 2B.

The insulating plate 61 is, for example, an alumina plate. The insulating plates 61 are provided on back sides of the radiation faces 12a of the tube bodies 12. The insulating plate 61 is clamped between the one of the radiation faces 12a and the one electrode plate 41, and the insulating plate 61 is clamped between the other radiation faces 12a and the other electrode plate 42.

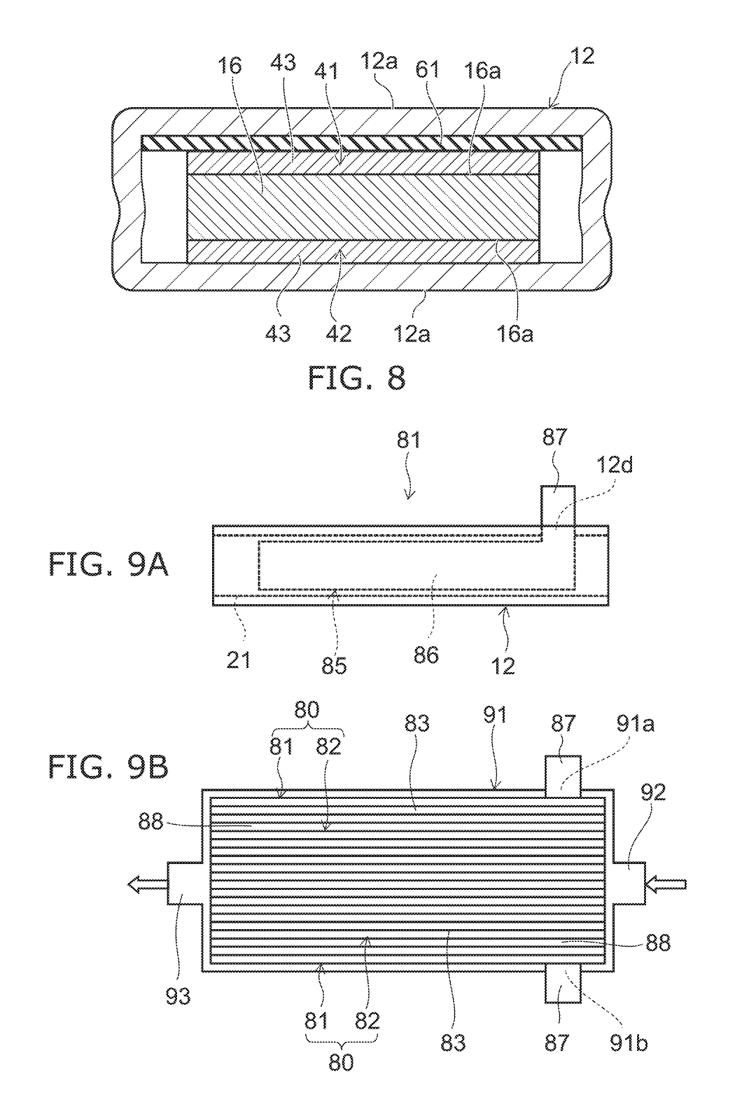

Alternatively, as shown in FIG. 8, the insulating plates 61 may also be provided only on the one electrode plate (in FIG. 8, for example, the electrode plate 41) side. A positive voltage is applied to the electrode plate 41, and the tube bodies 12 and the electrode plate 42 are grounded. The insulating plates 61 are interposed between the electrode plate 41 and the tube bodies 12 and stop the application of a positive voltage to the grounded tube bodies 12.

FIG. 9A shows another specific example of the heat generators 81.

Similar to the embodiment described above, the PTC elements 16 are housed in the tube bodies 12, and a pair of electrode plates 85 sandwich the PTC elements. The electrode plates 85 and the PTC elements 16 are wrapped in the insulating sheets 21.

The electrode plate 85 has a flat plate portion 86 bonded to the electrode face of the PTC element and an electrode terminal 87 protruding to outside of the tube body 12. The electrode terminal 87 is formed bent in an L shape to and integrally with one end portion of the flat plate portion 86. The electrode terminal 87 protrudes to outside of the tube body 12 from the side face of the tube body 12.

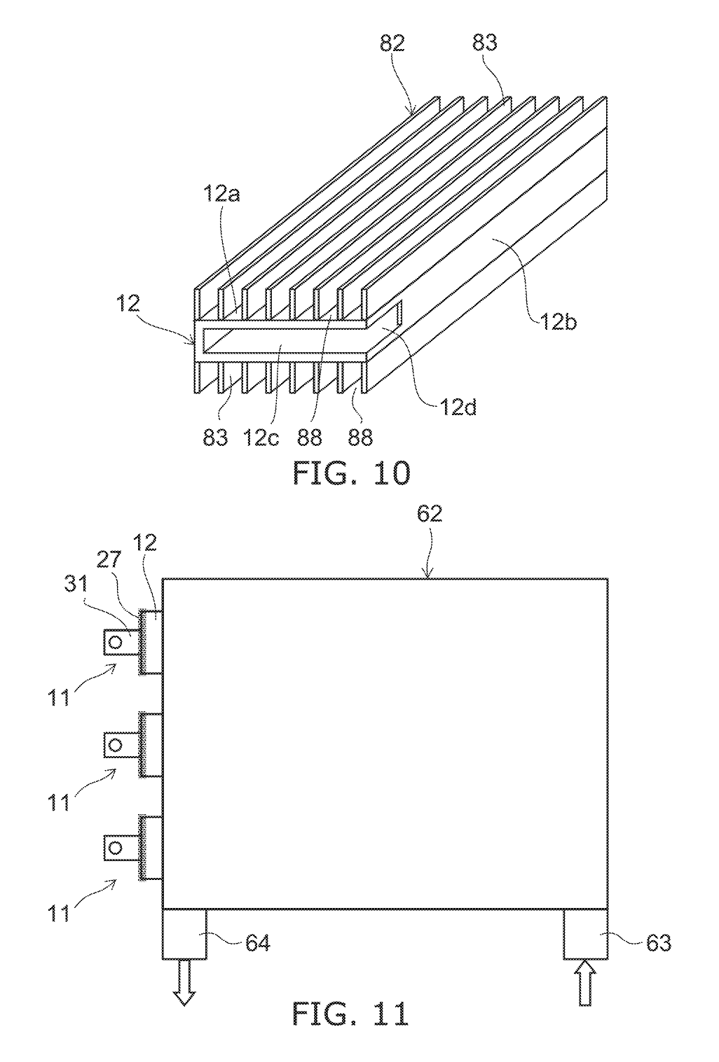

As shown in FIG. 10, in the portion close to one end portion of the side face 12b of the tube body 12, a slit 12d is formed. The electrode terminal 87 protrudes to outside of the tube body 12 from the slit 12d.

There is no side wall between an opening 12c in one end portion of the tube body 12 and the slit 12d, and the slit 12d is linked to the opening 12c on the side face 12b with the slit 12d formed therein. Accordingly, it is possible to insert the electrode terminal 87 protruding more than a width of the opening 12c to a position formed with the slits 12d. Similarly to the embodiment described above, a waterproof sealant is enclosed in the slit 12d and a liquid does not infiltrate inside the tube body 12.

FIG. 9B shows a schematic view of a car-mounted heater that is configured with heater units 80 having the heat generators 81 shown in FIG. 9A in combination with radiators 82, and has the heater units 80 housed in a case 91.

The radiators 82 have, as shown in FIG. 10, a plurality of fins 83 extending in the longitudinal direction of the tube body 12, for example. The fins 83 are provided on the radiation faces 12a of the tube body 12. Between the fins 83, flow paths 88 in which a liquid flows are formed.

They may be in a structure that the separated tube bodies 12 are bonded or brazed to the radiators 83, and alternatively the tube body 12 and the radiators 83 may also be molded integrally by, for example, extrusion molding.

In the specific example shown in FIG. 9B, two heater units 80, for example, are housed in the case 91. The case 91 has a flow inlet 92 and a flow outlet 93 for a liquid. The heater units 80 are housed in an internal space between the flow inlet 92 and the flow outlet 93 in the case 91.

The flow paths 88 in the heater units 80 have one end portion opposed to the flow inlet 92 and have the other end portion opposed to the flow outlet 93. The flow paths 88 extend in a direction joining the flow inlet 92 to the flow outlet 93. In a direction that intersects with the direction in which the flow paths 88 extend (in the orthogonal direction, for example, in the illustration), the electrode terminals 87 protrude.

The electrode terminal 87 of one of the heater units 80 protrudes to outside of the case 91 from a slit 91a formed in the case 91 and is connected to an electric cable. The other heater unit 80 protrudes to outside of the case 91 from a slit 91b formed in a face on an opposite side to the face formed with the slit 91a and is connected to an electric cable. In the slit 91a and the slit 91b, a waterproof sealant is enclosed.

Each electrode terminal 87 of the two heater units 80 protrudes in a direction opposite to each other. In addition, the electrode terminal 87 protrudes in a direction that intersects with the direction in which a liquid flows. Therefore, a flow of a liquid toward a draw-out portion of the electrode terminal 87 is not formed, and it is possible to suppress a decrease in the waterproof properties in the draw-out portion of the electrode terminals 87.

The flow inlet and the flow outlet for a liquid are not limited to be formed at positions facing each other. For example, as shown in FIG. 11, a flow inlet 63 and a flow outlet 64 may also be provided on a same face side in a case 62. The tube bodies 12 extend in a transverse direction in FIG. 11 in the case 62. A liquid flows in a direction that intersects with the longitudinal direction of the tube bodies 12 and further the liquid flows out in a direction that intersects with the longitudinal direction of the tube bodies 12.

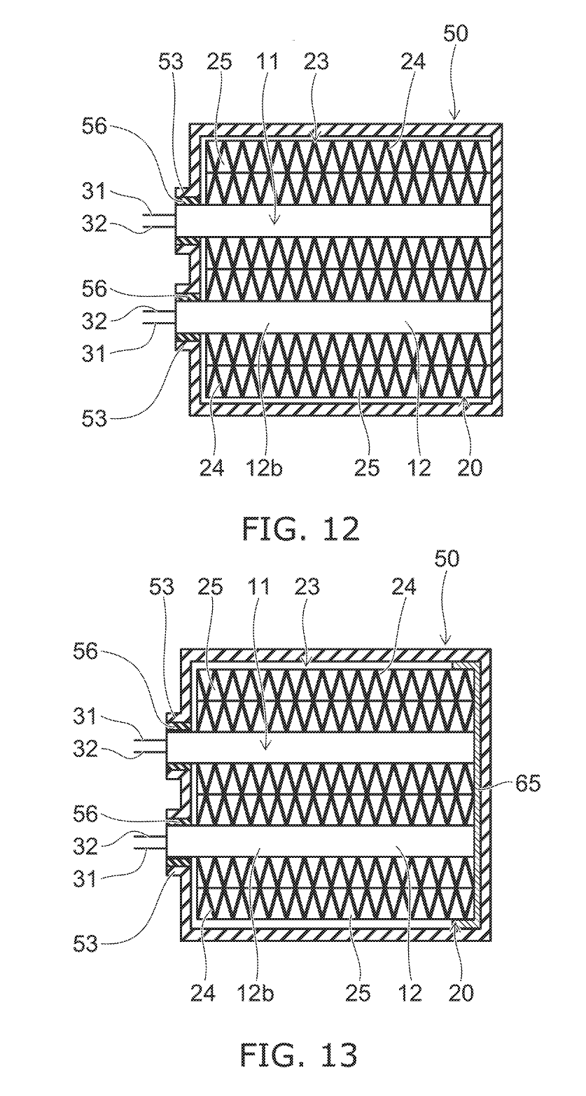

The other end portions of the tube bodies 12 from which the electrode terminals are not draw out may not protrude from the radiators 23 as shown in FIG. 12. The other end portions of the tube bodies 12 and the other end portions of the radiators 23 may also be in a structure to support the inner walls of the case 50 by contacting them.

In addition, as shown in FIG. 13, the other end portions of the tube bodies 12 and the other end portions of the radiators 23 may also be supported via, for example, a support member 65 having a C-shaped cross section.

In addition, there may not be a gap between the radiators 23 and the inner walls of the case 50. It should be noted that, as described above, by interposing a gap between the radiators 23 and the inner walls of the case 50, it is possible to suppress an amount of heat turned out to escape from the radiators 23 to the case 50, and it is possible to achieve a highly efficient car-mounted heater.

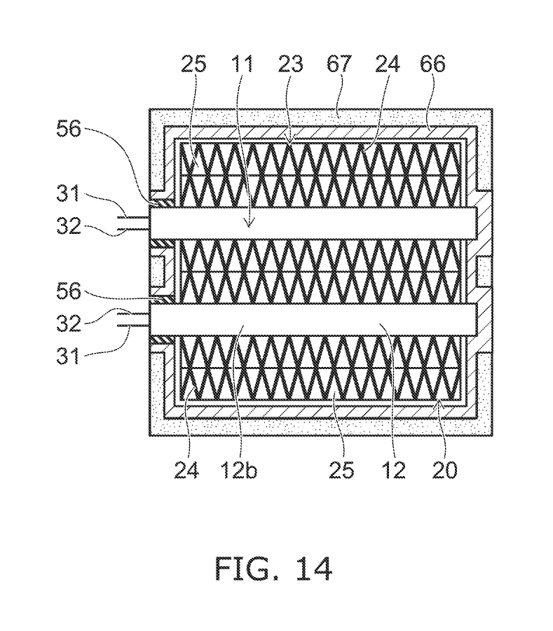

In addition, the case is not limited to be made of resin and may also be made of metal, such as aluminum, for example. A case made of metal can be enhanced in the strength. In addition, as shown in FIG. 14, in a case of using a case 66 made of metal, by providing a heat insulating material 67 on an outer face thereof, it is possible to suppress diffusion of the heat to outside.

The tube bodies 12 are not limited to be in a flattened shape of a rectangular tube and may also be in an elliptical or circular shape. It should be noted that, as a distance between the PTC elements and the radiation faces 12a of the tube bodies is shorter, it is possible to enhance the heat transfer efficiency to the radiation faces more.

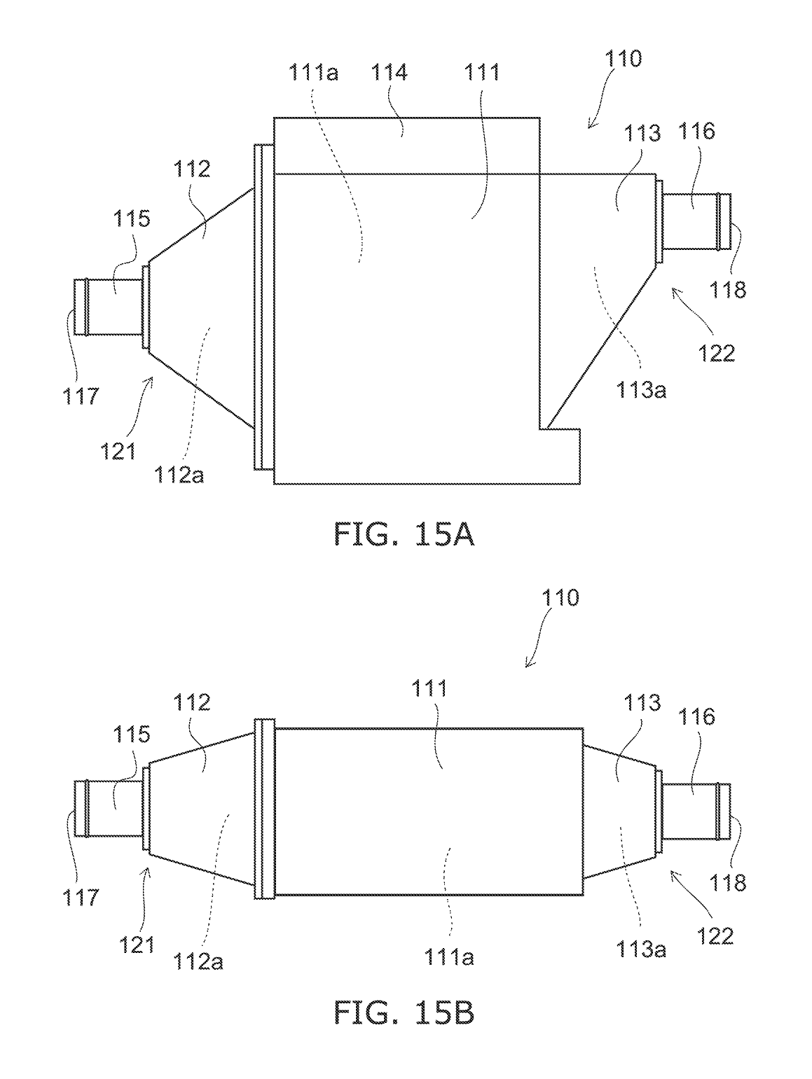

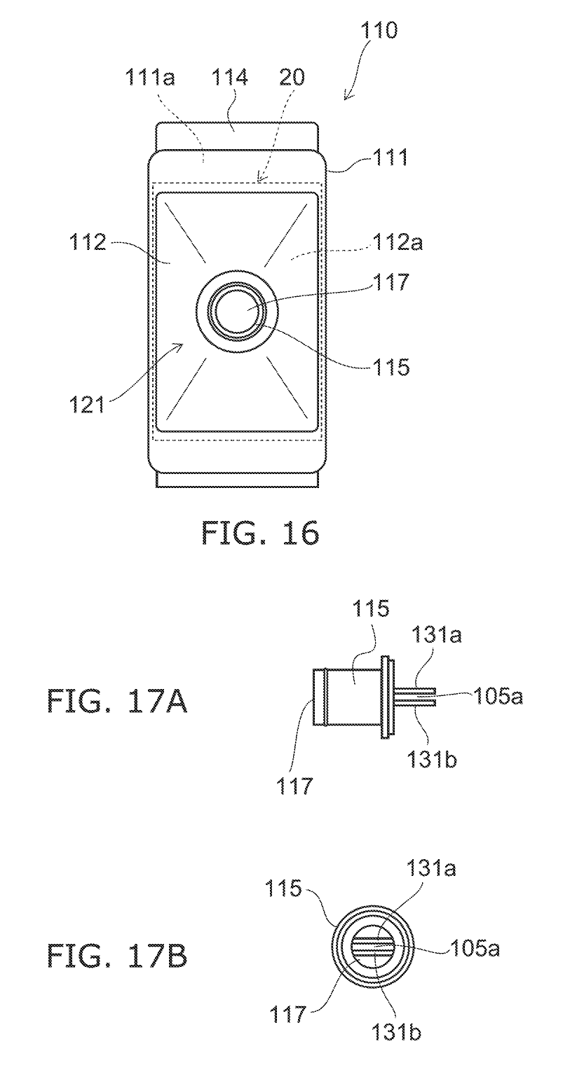

Next, FIG. 15A shows another specific example of a case 110. FIG. 15B is a top view of FIG. 15A. FIG. 16 is a front view of the left side in FIGS. 15A and 15B.

The case 110 has a main body portion 111, a flowing water introduction portion 121, and a flowing water lead-out portion 122. The main body portion 111 is formed in, for example, a rectangular tubular shape and has its one end provided with the flowing water introduction portion 121. The main body portion 111 has the other end opposed to the flowing water introduction portion 121 provided with the flowing water lead-out portion 122. The flowing water introduction portion 121 and the flowing water lead-out portion 122 are, for example, welded to the main body portion 111.

In the main body portion 111, an internal space 111a to house the heater units of the embodiments described above is formed. In addition, in an upper portion of the main body portion 111, an electrode formation portion 114 is provided that is similar to the electrode connection 53 described above.

The flowing water introduction portion 121 has a first tubular portion 115 and a second tubular portion 112. The first tubular portion 115 and the second tubular portion 112 are coupled by, for example, welding.

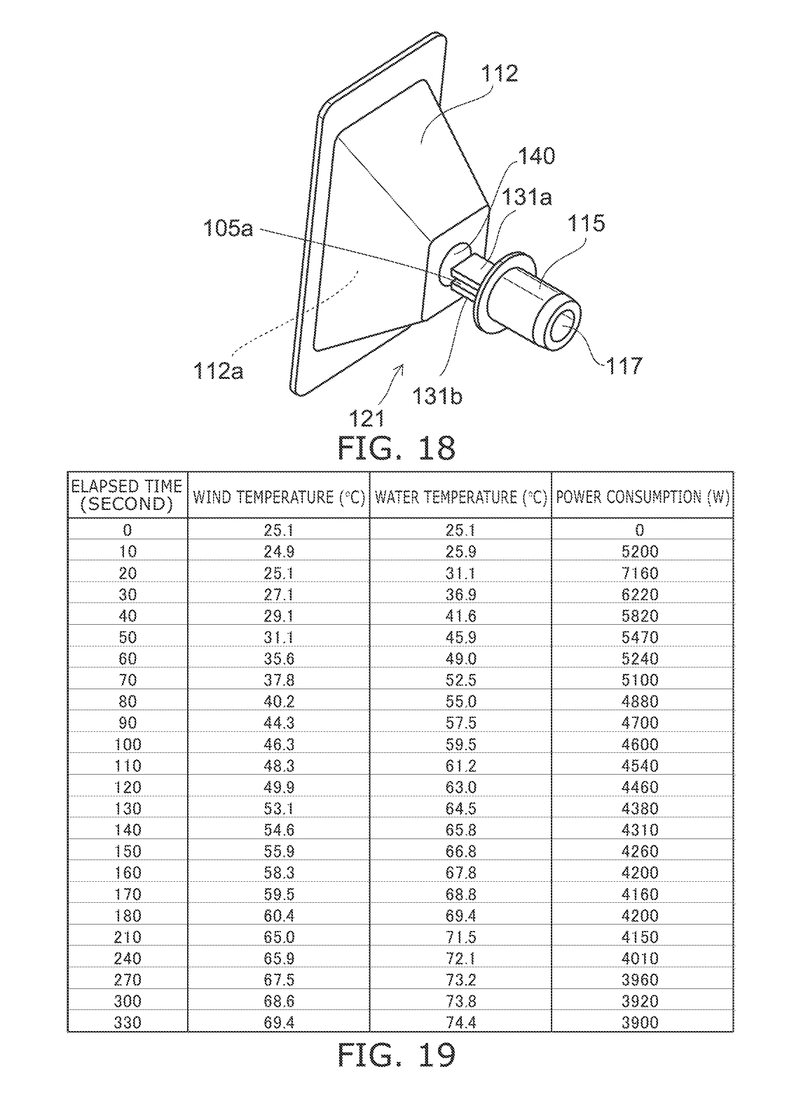

FIG. 18 shows a state before coupling of the first tubular portion 115 and the second tubular portion 112.

The first tubular portion 115 is formed in, for example, a cylindrical shape and has its one end formed with a flow inlet 117. The other end of the first tubular portion 115 is coupled to the second tubular portion 112.

The second tubular portion 112 has an external shape formed in, for example, a truncated pyramid shape. Inside the second tubular portion 112, a flowing water introduction space 112a is formed that has a cross-sectional area gradually enlarged from the first tubular portion 115 toward the internal space 111a of the main body portion 111. The cross-sectional area of the second tubular portion 112 is not limited to become wider continuously and gradually and may also become wider stepwise.

The flowing water introduction space 112a is linked to the flow inlet 117 and the internal space 111a of the main body portion 111. The flowing water introduction space 112a faces the entire one end portion of the internal space 111a.

As shown in FIGS. 17A and 17B and FIG. 18, the first tubular portion 115 is provided with diffusion guiding portions 131a, 131b that diffuse the liquid inflowing from the flow inlet 117 toward the internal space 111a of the main body portion 111.

The diffusion guiding portions 131a, 131b are formed in a plate shape and protrude from the other end opposite side to the one end having the flow inlet 117 formed in the first tubular portion 115. The diffusion guiding portion 131a and the diffusion guiding portion 131b oppose across a gap 105a.

The diffusion guiding portions 131a, 131b are inserted, as shown in FIG. 18, inside the second tubular portion 112 (flowing water introduction space 112a) through an opening 140 formed in an end portion on a side opposite to the main body portion 111 in the second tubular portion 112.

In FIG. 15A and FIG. 16, down is a direction that the gravity acts (in a vertical direction). The case 110 is attached to a vehicle, as shown in FIG. 15A and FIG. 16, in a position that the opposite side of the electrode formation portion 114 is directed to the direction that the gravity acts.

As shown in FIG. 16 viewing the flowing water introduction portion 121 side in that state, the internal space 111a has an end portion extending in a long rectangular shape in the vertical direction. In conformity with this, a region facing the internal space 111a in the flowing water introduction space 112a also extends in a long rectangular shape in the vertical direction.

The diffusion guiding portions 131a and 131b overlap in the vertical direction across the gap 105a as shown in FIG. 18. Accordingly, as the diffusion guiding portions 131a and 131b are inserted into the flowing water introduction space 112a, a space on an entrance side of the flowing water introduction space 112a is partitioned into a space above the diffusion guiding portion 131a, a space below the diffusion guiding portion 131b, and the gap 105a between the diffusion guiding portion 131a and the diffusion guiding portion 131b.

The second tubular portion 112 of the flowing water introduction portion 121 and a second tubular portion 113 of the flowing water lead-out portion 122 may also have an external shape in a truncated cone shape, a pyramid shape, and a conical shape, not limited to a truncated pyramid shape.

Similarly to the embodiments described above, the flow paths 25 of the radiators 23 in the heater units 80 housed in the internal space 111a of the main body portion 111 have one end opposed to the flowing water introduction space 112a. The flow paths have the other end opposed to a flowing water lead-out space 113a. In the internal space 111a of the main body portion 111, the flow paths 25 of the radiators 23 extend in a direction joining the flowing water introduction space 112a to the flowing water lead-out space 113a. A portion of the heater units may enter the flowing water introduction space 112a or the flowing water lead-out space 113a.

The liquid inflowing from the flow inlet 117 is lead through the flowing water introduction space 112a to the flow paths 25 of the radiators 23 housed in the internal space 111a. The flowing water introduction space 112a has a cross-sectional area formed gradually enlarged from the flow inlet 117 side toward the internal space 111a. Therefore, it is possible to lead the liquid inflowing from the flow inlet 117 by diffusing uniformly to all of the flow paths 25 formed in the radiators 23. As a result, it is possible to achieve high heat exchange efficiency.

Further, on the entrance side of the flowing water introduction space 112a, the diffusion guiding portions 131a and 131b are provided that are described with reference to FIGS. 17A, 17B, and FIG. 18. The gap 105a formed between the diffusion guiding portion 131a and the diffusion guiding portion 131b is narrow. Therefore, it is suppressed that the liquid introduced from the flow inlet 117 opposed to almost center of the cross section of the internal space 111a in a long rectangular shape in a vertical direction advances biased to the center in the cross section of the internal space 111a. The liquid is also diffused above the diffusion guiding portion 131a and below the diffusion guiding portion 131b. As a result, the liquid is lead uniformly over the entire cross section of the internal space 111a.

As shown in FIG. 24, an upper face of the diffusion guiding portion 131a may also be a tapered face of an upward inclination toward the internal space 111a and a lower face of the diffusion guiding portion 131b be a tapered face of a downward inclination toward the internal space 111a.

In the embodiment as well, the plurality of flow paths 25 are partitioned by the plurality of heated fins 24, the radiation faces 12a of the tube bodies 12, and the metal plates 26. Accordingly, the liquid flowing in the flow paths 25 is heated by the heat exchange between the fins 24, the radiation faces 12a, and the metal plates 26 and flows out through the flowing water lead-out space 113a to outside the case 110 from a flow outlet 118. That is, the heater units 80 perform heat exchange highly efficiently by directly contacting the liquid.

A space in an end portion on the main body portion 111 side in the flowing water introduction space 112a and a space in an end portion on the main body portion 111 side in the flowing water lead-out space 113a extend over almost the entire cross section of the internal space 111a. Therefore, it is possible to flow a liquid uniformly with no bias in the cross sectional direction from end to end of all of the flow paths 25 built in the heater units. As a result, it is possible to achieve high heat exchange efficiency.

In addition, as shown in FIG. 15A, the flowing water lead-out portion 122 has a first tubular portion 116 located above the first tubular portion 115 of the flowing water introduction portion 121 and is at a position opposed to an upper portion of the internal space 111a. That is, the flow outlet 118 is at a position opposed to the upper portion of the internal space 111a. Therefore, it is easy to discharge bubble that decreases the heat exchange efficiency between the liquid and the heater units from the internal space 111a through the flow outlet 118.

Here, a car-mounted heater using the case 110 described above is connected to a circulation system including a heater core and a water pump to perform testing.

Hot water generated in the car-mounted heater is supplied to the heater core and flows in a pipe included in the heater core. To the heater core, an air is blown from a blower. The heat of the hot water flowing in the pipe of the heater core is transferred via the fins included in the heater core to the air blown from the blower.

The total amount of water in the circulation system is approximately 1.55 liters. The wind speed of the air blown to the heater core is from 2.5 to 2.9 (m/s). The voltage applied to the heater units housed in the case 110 is 350 (V) for direct current.

FIG. 19 shows a wind temperature (° C.), a water temperature (° C.), and power consumption (W) for each elapsed time (seconds) at that time. The wind temperature is measured at a front face on a downwind side in the heater core. The water temperature is a water temperature at an entrance of the heater core. The power consumption is power consumption (a product of the applied voltage and the current flowing at that time) in the heater units.

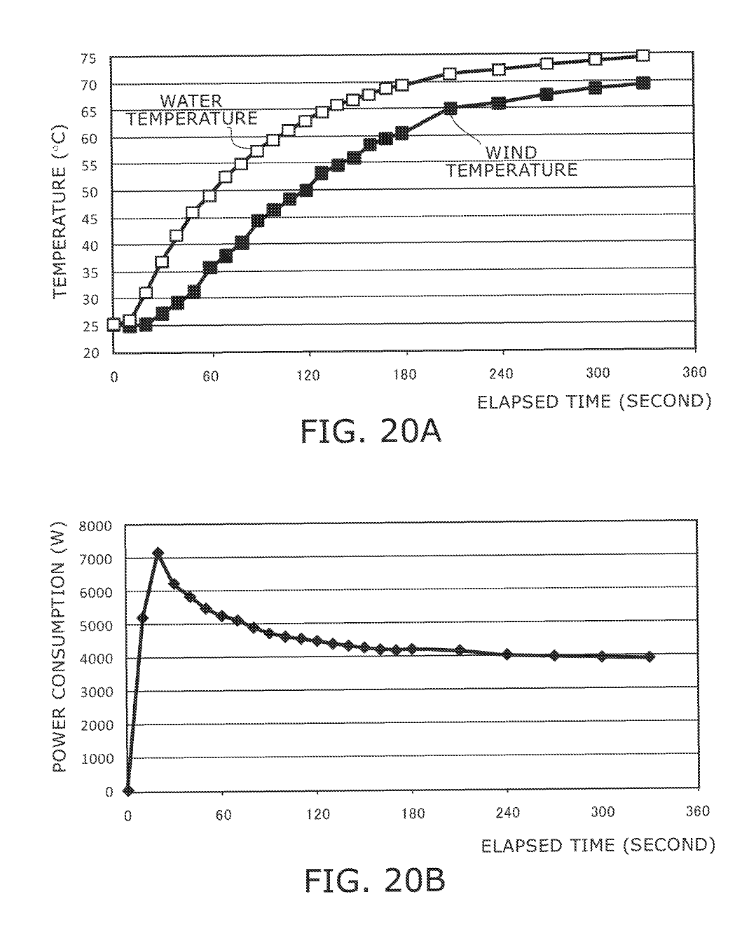

In addition, FIG. 20A is a graph showing changes in the water temperature and the wind temperature relative to the elapsed time, and FIG. 20B is a graph showing changes in the power consumption relative to the elapsed time. The power consumption rises sharply due to the influence of an inrush current at the time of power activation.

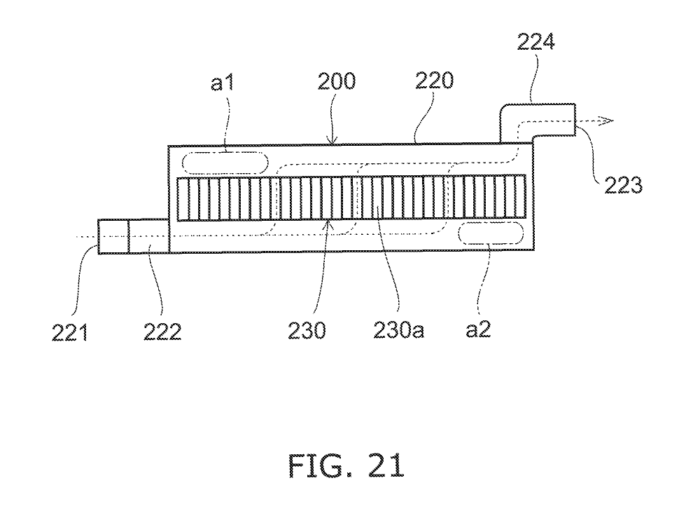

In addition, as Comparative example to the car-mounted heater of the embodiments described above, similar testing is performed for a car-mounted heater shown in FIG. 21.

A case 200 of the car-mounted heater of Comparative example has a main body portion 220 and has heater units 230 housed inside. The heater units 230 are same as the heater units of the embodiments. Accordingly, the car-mounted heater of Comparative example is different in the case 200 from the car-mounted heater of the embodiments.

The main body portion 220 has one end portion provided with a flowing water introduction portion 222 having a flow inlet 221 formed therein. Down in FIG. 21 is the direction that the gravity acts, and the car-mounted heater of Comparative example is placed in a position shown in FIG. 21. That is, the flowing water introduction portion 222 is connected to a lower portion in the one end portion of the main body portion 220.

The flowing water introduction portion 222 has an end portion on the main body portion 220 side with a width in a depth direction of the paper almost same as the width in the depth direction of the paper. However, the flowing water introduction portion 222 is not provided all over a height direction of the main body portion 220. The flowing water introduction portion 222 is provided only in a lower portion in the height direction of the main body portion 220.

The main body portion 220 has the other end portion with an upper face provided with a flowing water lead-out portion 224. The flowing water lead-out portion 224 is formed in a cylindrical pipe shape and is connected to almost a center in a width direction (depth direction of the paper) on an upper face of the main body portion 220.

Flow paths 230a formed of fins in the heater units 230 extend in a vertical direction in the main body portion 220.

The car-mounted heater of Comparative example is connected to a circulation system including a heater core and a water pump similarly to the car-mounted heater of the embodiments to perform testing.

The total amount of water in the circulation system is approximately 1.3 liters. The wind speed of the air blown to the heater core is from 2.5 to 2.8 (m/s). The voltage applied to the heater units 230 is 350 (V) for direct current.

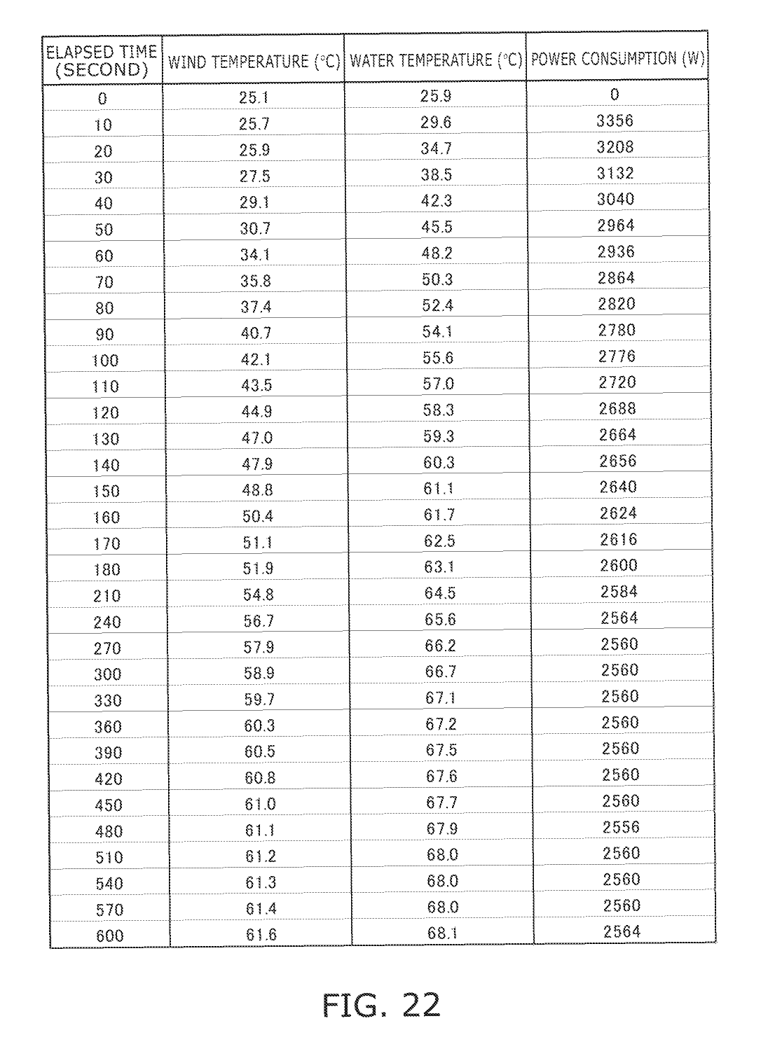

FIG. 22 shows a wind temperature (° C.), a water temperature (° C.), and power consumption (W) for each elapsed time (seconds) at that time. The wind temperature is measured at a front face on a downwind side in the heater core. The water temperature is a water temperature at an entrance of the heater core. The power consumption is power consumption (a product of the applied voltage and the current flowing at that time) in the heater units 230.

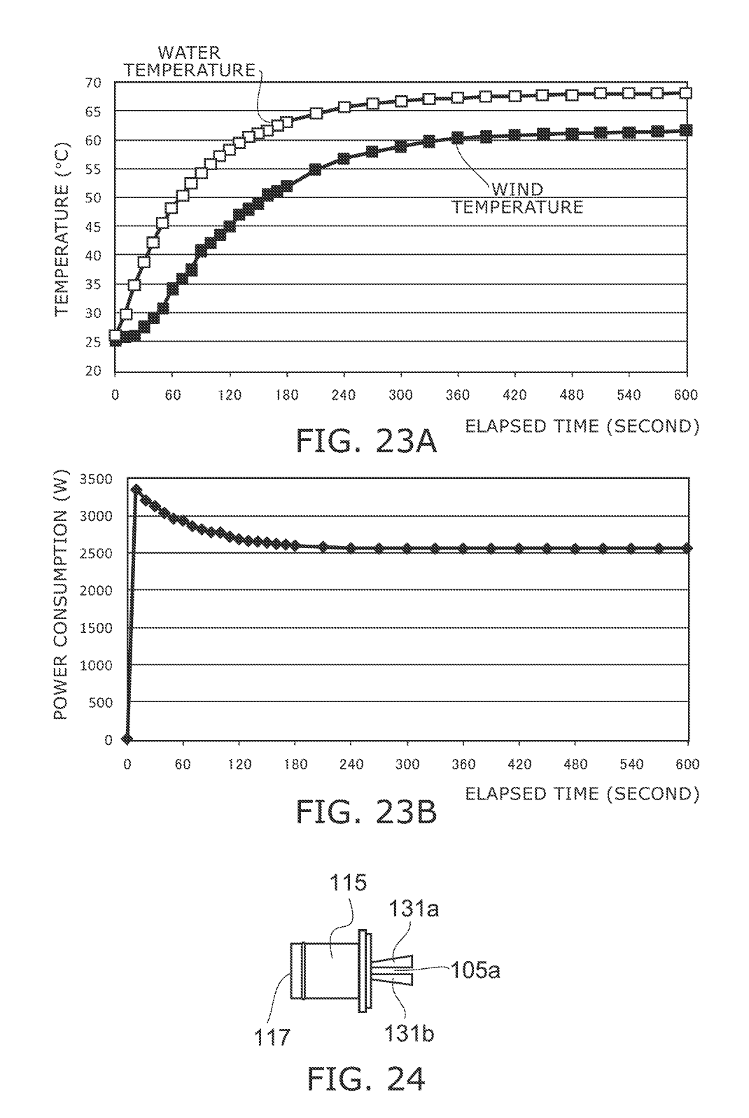

In addition, FIG. 23A is a graph showing changes in the water temperature and the wind temperature relative to the elapsed time, and FIG. 23B is a graph showing changes in the power consumption relative to the elapsed time. The power consumption rises sharply due to the influence of an inrush current at the time of power activation.

To compare the wind temperature, the water temperature, and the power consumption in each state of becoming almost constant, in the car-mounted heater of Comparative example, all of the wind temperature, the water temperature, and the power consumption are lower than the wind temperature, the water temperature, and the power consumption of the car-mounted heater of the embodiments.

As shown in FIG. 21, in the car-mounted heater of Comparative example, water is introduced into a lower portion of the main body portion 220 of the case 200 in which the heater units 230 are housed. Then, the flowing water lead-out portion 224 is provided on an upper face of the other end portion of the main body portion 220. Accordingly, while the water introduced into the main body portion 220 advances toward the other end portion of the main body portion 220 as shown in a broken line arrow in FIG. 21, it is guided by the flow paths 230a of the heater units 230 extending in a vertical direction to be directed above in the main body portion 220 and lead to the flowing water lead-out portion 224.

In such a structure, stagnation of the water easily develops in an upper portion on the entrance side (an area shown by a dash dotted line a1) in the main body portion 220 and a lower portion on an exit side (an area shown by a dash dotted line a2). Accordingly, in the areas a1, a2, the water temperature is prone to increase.

The PTC elements have properties to discharge more energy as being cooled more. Accordingly, in the areas a1, a2 at high water temperatures, the efficiency of taking out the output of the PTC elements decreases. This leads to a decrease in the efficiency of the entire heater units 230.

In contrast, in the embodiments, as described above, the flowing water introduction space has a cross-sectional area formed enlarged from the flow inlet side toward the internal space of the main body portion and is opposed to one end of the flow paths built in the heater units. Further, the space in the end portion on the main body portion side in the flowing water introduction space and the space in the end portion on the main body portion side in the flowing water lead-out space extend over almost the entire cross section of the internal space. Accordingly, in the embodiments, it is possible to form a flow of water uniformly with no bias in the internal space having the heater units housed therein. As a result, it is possible to achieve high efficiency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

### REFERENCE SIGN LIST

11 heat generator
12 tube body
12a radiation face
15 spacer
16 PTC element
16a electrode face
20 heater unit
21 insulating sheet
23 radiator
24 fin
25 flow path
26 metal plate
27, 28 sealant
31, 32 electrode terminal
41, 42 electrode plate
45 main body portion
46 flowing water introduction portion
46a flowing water introduction space
47 flowing water lead-out portion
47a flowing water lead-out space
50 case
51a flow inlet
52a flow outlet
53 electrode connection
54 slit
55 fitting portion
60 gap
61 insulating plate
71-73 electric cable
100 internal space
110 case
111 main body portion
112a flowing water introduction space
113a flowing water lead-out space
117 flow inlet
118 flow outlet
121 flowing water introduction portion
122 flowing water lead-out portion
131a, 131b diffusion guiding portion

What is claimed is:

1. A highly-efficient, hot-water generating, car-mounted heater with an internal liquid flow path, comprising:
a heater unit, including
a PTC (positive temperature coefficient) element having a pair of electrode faces,
a pair of electrode plates bonded to each of the pair of electrode faces sandwiching the PTC element,
an insulating sheet wrapping the PTC element and the electrode plates, and having flexibility, thermal conductivity, and electrical insulating properties,
a tube body in a flattened shape housing the PTC element and the electrode plates wrapped in the insulating sheet, and having a pair of radiation faces in a plate shape opposed to each of the pair of electrode faces,
a seal material sealing openings in both end portions of the tube body in a longitudinal direction, and
a radiator provided on the radiation faces of the tube body, and having a plurality of fins and a plurality of flow paths that are partitioned by the plurality of fins and extend in a direction that intersects with the longitudinal direction of the tube body; and
a case having a flow inlet for a liquid and a flow outlet for the liquid, wherein
the heater unit is housed between the flow inlet and the flow outlet in the case with one ends of the flow paths of the radiator made to oppose the flow inlet and the other ends of the flow paths made to oppose the flow outlet.

2. The heater according to claim 1, wherein
both end portions of the tube body in the longitudinal direction protrude from the radiator and do not overlap the radiator, and
the both end portions are attached to the case.

3. The heater according to claim 2, wherein
the radiator does not contact an inner wall of the case, and
a gap exists between the radiator and the inner wall of the case.

4. The heater according to claim 2, wherein one end portion of the electrode plate protrudes from the opening in one end portion of the tube body in the longitudinal direction to outside the tube body and to outside the case to be connected to an electric cable.

5. The heater according to claim 4, wherein the other end portion of the tube body protruding from the radiator fits in a joint portion provided in the case.

6. The heater according to claim 1, wherein the radiator further includes a metal plate surrounding around the fins.

7. A highly-efficient, hot-water generating, car-mounted heater with an internal liquid flow path, comprising:
a case having an internal space in which a liquid flows; and
a heater unit housed in the internal space and performing heat exchange by directly contacting the liquid, wherein
the heater unit includes
a PTC (positive temperature coefficient) element having an electrode face,
an electrode plate bonded to the electrode face,
an insulator overlapped at least on a face of the electrode plate on the side opposite to the PTC element,
a tube body housing the PTC element, the electrode plate, and the insulator, and having a radiation face opposed to the electrode face of the PTC element,
a seal material sealing openings in both end portions of the tube body, and
a radiator provided on the radiation face of the tube body and having a fin forming a flow path in which the liquid flows, and wherein
one end portion of the tube body is located outside the internal space of the case, and one end portion of the electrode plate protrudes from the one end portion of the tube body to outside the case to be connected to an electric cable.

8. The heater according to claim 7, wherein the flow path has a volume larger than a volume of a space outside the flow path in the internal space.

9. The heater according to claim 7, wherein inside the electrode plate in the one end portion of the tube body, an insulating spacer is provided.

10. A highly-efficient, hot-water generating, car-mounted heater with an internal liquid flow path, comprising:
a case in which a liquid flows inside; and
a heater unit housed inside the case and performing heat exchange by directly contacting the liquid, wherein
the heater unit includes
a PTC (positive temperature coefficient) element having an electrode face,
an electrode plate bonded to the electrode face,
an insulator overlapped at least on a face of the electrode plate on the side opposite to the PTC element,
a tube body housing the PTC element, the electrode plate, and the insulator, and having a radiation face opposed to the electrode face of the PTC element,
a seal material sealing openings in both end portions of the tube body, and
a radiator provided on the radiation face of the tube body and having a fin forming a flow path in which the liquid flows, wherein
the case includes
a main body portion having an internal space to house the heater unit and
a flowing water introduction portion provided in one end of the main body portion, and wherein
the flowing water introduction portion includes
a flow inlet for the liquid and
a flowing water introduction space provided between the flow inlet and the internal space, having a cross-sectional area enlarged from the flow inlet toward the internal space, and facing one end of the flow path formed in the radiator.

11. The heater according to claim 10, wherein the case further includes a flowing water lead-out portion provided in the other end of the main body portion opposed to the flowing water introduction portion, and wherein
the flowing water lead-out portion includes
a flow outlet for the liquid and
a flowing water lead-out space provided between the internal space and the flow outlet and having a cross-sectional area decreased from the internal space toward the flow outlet.

12. The heater according to claim 10, wherein a diffusion guide portion to diffuse the liquid inflowing from the flow inlet toward the internal space is provided in the flowing water introduction portion.
